(19) United States
(12) Patent Application Publication
(10) Pub. No.: US 2026/0111133 A1
(43) Pub. Date: Apr. 23, 2026

(54) METHOD, SYSTEM, AND STORAGE MEDIUM FOR COMPOSING DSS (DISTRIBUTED STORAGE SYSTEM) NODE

(71) Applicant: Lenovo Enterprise Solutions (Singapore) Pte. Ltd., Singapore (SG)

(72) Inventors: Fred Allison Bower, III, Durham, NC (US); CheKim Chhuor, Shanghai (CN); Caihong Zhang, Shanghai (CN)

(21) Appl. No.: 19/116,940

(22) PCT Filed: Jul. 21, 2023
(86) PCT No.: PCT/CN2023/108549

§ 371 Date: Mar. 28, 2025

(51) Int. Cl. G06F 3/06

(52) U.S. Cl. CPC G06F 3/0631; G06F 3/0613; G06F 3/0635; G06F 3/067

(57) ABSTRACT

A method of composing a DSS (distributed storage system) node by a resource manager includes receiving a node composition request, sending to a candidate CF (composable fabric) target a storage capacity inquiry according to the node composition request, receiving a storage capacity value in response to the storage capacity inquiry, determining whether the storage capacity value meets a storage capacity threshold, and upon determining that the storage capacity value meets the storage capacity threshold, composing the DSS node by including the candidate CF target.

### TECHNICAL FIELD

The present disclosure relates to the technical field of composition of a client or a node in a composable computing environment, in particular, a composition of a Ceph node. Ceph is a distributed object storage system which can distribute data in the form of objects across several servers.

### BACKGROUND

Distributed file systems aim to distribute storage capacity of all shared resources. Often, due to the dynamic nature of the client pool utilizing the shared resources, workload assignment and service level agreement (SLA) requirements may not be readily or adequately managed in certain distributed file systems.

### SUMMARY

One aspect of the present disclosure provides a method of composing a DSS (distributed storage system) node by a resource manager. The method includes receiving a node composition request, sending to a candidate CF (composable fabric) target a storage capacity inquiry according to the node composition request, receiving a storage capacity value in response to the storage capacity inquiry, determining whether the storage capacity value meets a storage capacity threshold, and upon determining that the storage capacity value meets the storage capacity threshold, composing the DSS node by including the candidate CF target. In certain embodiments, the DSS node may be a Ceph node or a Ceph client. The composable fabric (CF) may be an Intel Rack Scale Design (RSD) and the CF target may be an RSD target in certain embodiments.

Another aspect of the present disclosure provides a computing apparatus including a memory and a processor coupled to the memory, where the processor is configured to perform, via a resource manager, a method of composing a DSS node, and where method includes receiving a node composition request, sending to a candidate CF target a storage capacity inquiry according to the node composition request, receiving a storage capacity value in response to the storage capacity inquiry, determining whether the storage capacity value meets a storage capacity threshold, and upon determining that the storage capacity value meets the storage capacity threshold, composing the DSS node by including the candidate CF target.

Another aspect of the present disclosure provides a non-transitory computer-readable storage medium storing computer program instructions executable by a processor to perform, via a resource manager, a method of composing a DSS, where the method includes receiving a node composition request, sending to a candidate CF target a storage capacity inquiry according to the node composition request, receiving a storage capacity value in response to the storage capacity inquiry, determining whether the storage capacity value meets a storage capacity threshold, and upon determining that the storage capacity value meets the storage capacity threshold, composing the DSS node by including the candidate CF target.

### BRIEF DESCRIPTION OF THE DRAWINGS

For a more complete understanding of the embodiments of the present disclosure and associated advantages, reference will now be made to the following description in conjunction with the accompanying drawings.

FIG. 1 is a schematic diagram of a computing system according to one embodiment of the present disclosure;

FIG. 1A is a schematic diagram of a CF target referenced in FIG. 1 according to another embodiment of the present disclosure;

FIG. 1B is a schematic diagram of a resource manager referenced in FIG. 1 according to yet another embodiment of the present disclosure;

FIG. 1C is a schematic diagram of an alternative arrangement to the DSS node referenced in FIG. 1 according to yet another embodiment of the present disclosure;

FIG. 2 is a flow diagram of a method of composing a DSS node according to yet another embodiment of the present disclosure;

FIG. 3 is a flow diagram of a process that may be integrated into the method of FIG. 2 according to yet another embodiment of the present disclosure; and

FIG. 4 is a flow diagram of a process that may be integrated into the method of FIG. 2 according to yet another embodiment of the present disclosure.

### DETAILED DESCRIPTION OF THE EMBODIMENTS

In view of the descriptions to follow regarding embodiments of the present disclosure in conjunction with the accompanying drawings, aspects, advantages, and prominent features of the present disclosure will become readily apparent to those skilled in the art.

Various embodiments described below are merely illustrative and should not be construed as limiting the scope of the present disclosure in any particular way. The following description with reference to the accompanying drawings is to assist in a comprehensive understanding of exemplary embodiments of the present disclosure as defined by the claims and their equivalents. The following description includes a variety of specific details; but these details should be considered as exemplary and illustrative only. Accordingly, those of ordinary skill in the art should recognize that various changes and modifications may be made to the embodiments described herein without having to deviate from the scope and spirit of the present disclosure. Descriptions of well-known functions and constructions may be omitted for clarity and brevity. In addition, the same reference numerals are used for the same or similar functions and operations throughout the drawings. In addition, although schemes with different features may be described in different embodiments, those skilled in the art should realize that all or part of the features of different embodiments may be combined to form an embodiment without departing from the spirit and scope of the present disclosure.

Distributed file systems aim to distribute storage capacity of all shared resources. Often due to the dynamic nature of the client pool utilizing the shared resources, workload assignment and service level agreement (SLA) requirements may not be readily or adequately managed in certain distributed file systems.

Further, shared devices may not be aware of their workload affinity other than through inference based upon data access. In some instances, the storage controller in a storage array supports SLA and wear optimization by managing the underlying storage in the array in a manner that is opaque to the workload. However, this approach may be limited to a single storage array, which has a finite size and typically higher cost than simple direct-attached storage arrays with a distributed file system for sharing. Hyper-converged systems with software-defined storage may be impractically inflexible in their configurations and do not readily scale to large numbers of clients and storage pools.

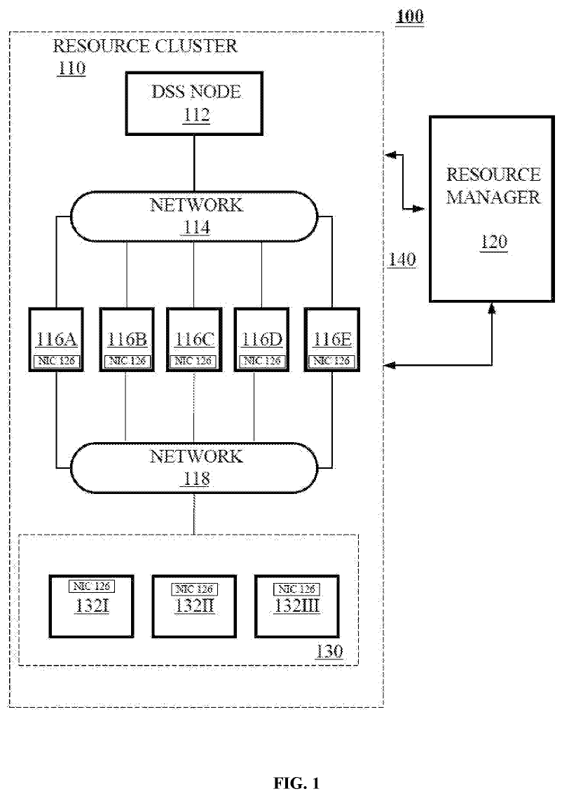

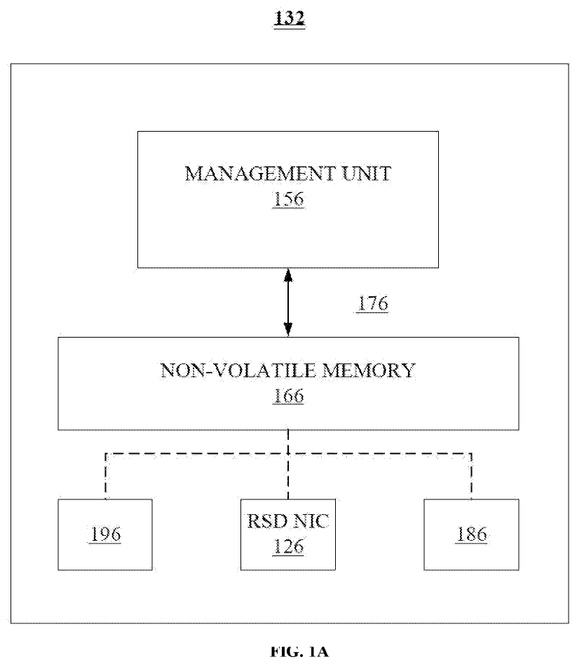

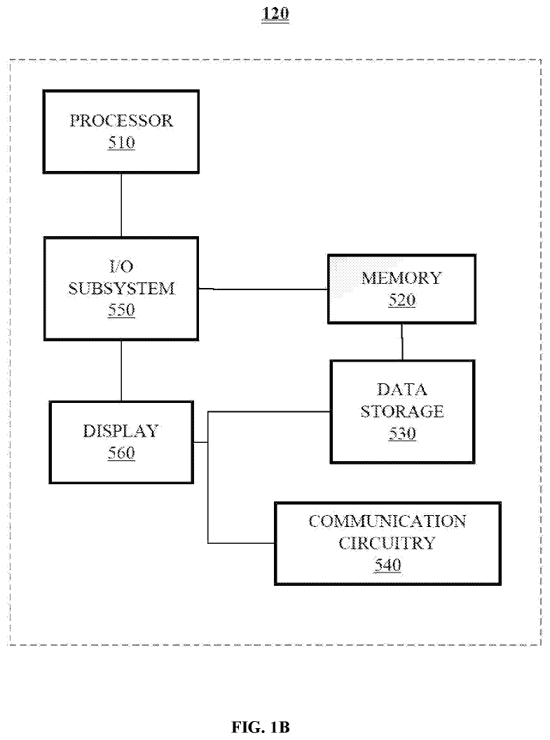

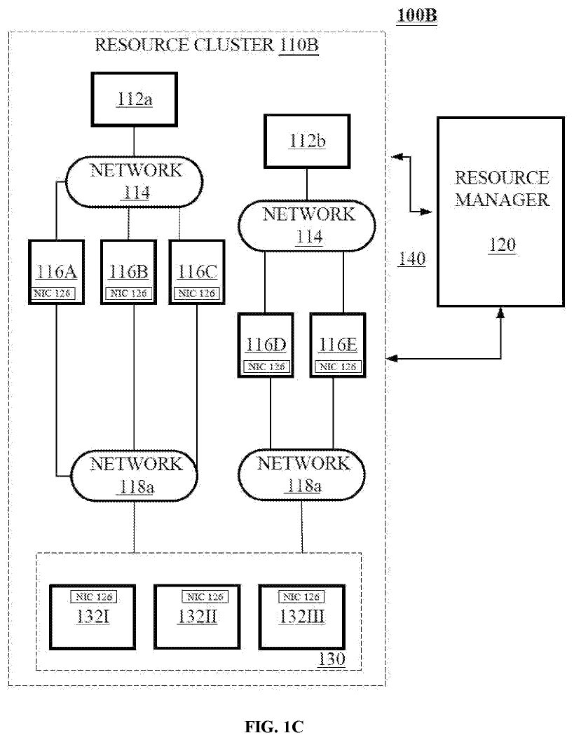

One or more embodiments of the present disclosure provide a resource manager or software composer 120 of FIG. 1 to be detailed below, such as a pod manager, that is situated in the device hierarchy in such a way as to have visibility to the nodes and the shared resources. One exemplary resource manager or composer is a pod manager, such as one used in the Ceph and Rack-Scale Design (RSD) architecture. Ceph is a distributed object storage system which can distribute data in the form of objects across several discs or servers. This type of architecture enables a storage cluster to be built without limitation on size.

FIG. 1 is a schematic diagram of a computing environment 100 according to one or more embodiments of the present disclosure. The computing environment 100 includes a resource cluster 110 and the resource manager 120 in data communication with each other via communication channel 140. In certain embodiments, the resource cluster 110 may be a pod, and the resource manager 120 may be a pod manager.

The resource cluster 110 includes a DSS (distributed storage system) node 112, a plurality of cluster servers such as CF (composable fabric) initiators 116A, 116B, 116C, 116D, and 116E in communication with the DSS node 112 via a network 114. Although the five initiators, namely cluster servers 116A, 116B, 116C, 116D, and 116E, are depicted in FIG. 1, fewer or more initiators may be in communication with the DSS node 112 via the network 114. In other words, the number of individual server devices included in the composition of DSS node 112 may vary dependent upon any given project and/or node/client requirements. In certain embodiments, the DSS node may be a Ceph node or a Ceph client. The composable fabric (CF) may be an Intel Rack Scale Design (RSD) and the CF target may be an RSD target in certain embodiments. In certain embodiments, the CF initiators 116A, 116B, 116C, 116D, and 116E may each be an RSD initiator. In certain embodiments also, the term “Ceph node” and the term “Ceph client” may be used interchangeably.

As illustratively depicted in FIG. 1, the DSS node 112 communicates with the network 114 via communication medium such as a management network interface card (NIC) 126, which is a hardware connecting a computing device to a network. However, any suitable communication medium other than the NIC, which may be a switching fabric such as a Peripheral Component Interconnect Express (PCIe), Infiniband, Omni-Path, or Ethernet network, may be employed to communicatively connect the DSS node 112 and the network 114.

The CF initiators 116A, 116B, 116C, 116D, and 116E communicate with the DSS node 112 through the network 114 and the communication medium such as NIC 126, respectively. Communication interfaces such as NIC 126 may each be a management NIC. However, any suitable communication interfaces other than the NIC may be employed to communicatively connect the network 114 and the plurality of CF initiators such as CF initiators 116A, 116B, 116C, 116D, and 116E. Furthermore, any one of the CF initiators such as CF initiators 116A, 116B, 116C, 116D, and 116E may communicate with the network 114 via an independently selected communication interface.

The CF targets 1321, 132II, and 132III communicate with the DSS node 112 through the network 118 via the communication medium such as NIC 126, respectively. Communication interfaces such as NIC 126 may each be a management NIC. However, any suitable communication interfaces other than the NIC may be employed to communicatively connect the network 118 and the plurality of CF targets, such as CF targets 1321, 132II, and 132III. Furthermore, any one of the CF targets 132 may communicate with the network 118 via an independently selected communication interface.

In one embodiment, as shown in FIG. 1, the resource manager 120 may compose the DSS node 112. The DSS node 112 may be connected to one or more CF initiators 116A, 116B, 116C, 116D, and 116E (i.e., a Ceph cluster server) to manage its storage needs. Each initiator 116 in the Ceph cluster may also be referred to as a CF initiator 116. In such a cluster, a CF initiator 116 establishes one or more logical connections with one or more intended CF targets 132. The CF initiator 116 can be suspended and restored to transfer data and commands as needed by DSS node 112. The CF initiator 116 may be connected to one or more target storage devices 132, which may be referred to as CF target 132. In certain embodiments, CF targets such as CF target 132 may be RSD targets.

In one example, the DSS node 112 may send requests to the resource manager 120 to request more storage. The resource manager 120 may allocate one or more CF targets 132 (i.e., shared resources) to meet certain storage needs of the DSS node 112. The CF targets 1321, 132II, or 132III may each have locally attached non-volatile memories (NVMe) disk drives. The NVMe disks of the CF targets 132 may be mapped to the corresponding Ceph cluster server or the CF initiator 116 according to the system composition. Accordingly, the resource manager 120 may perform a search across the available storage devices, such as across the available CF targets 132, to identify available storage capacity. In some embodiments, the resource manager 120 may further identify available storage capacity with a good fit for wear level and Input/Output Operation Per Second (IOPS) performance, based upon workload requests or profile information of the DSS node 112. In some embodiments, the resource manager 120 may select one or more CF targets 132, and allocate the CF target 132 to one or more of the CF initiators 116 to re-build the DSS node 112. This type of composition and re-composition of resources may be leveraged to rebalance configurations as usage and workload of the DSS node 112 changes over time.

FIG. 1A is a schematic diagram of the CF targets 132. The CF targets 1321, 132II, or 132III may include one or more NVMe disks 166, which may be virtual or physical. The NVMe disks are in communication with a management unit 156 via a communications bus 176. NVMe disks are also mapped to the CF initiators 116. That is, the virtual NVMe disks of the CF initiators 116A, 116B, 116C, 116D, and 116E are remotely mapped to the physical NVMe disks 166 of the relevant CF targets 1321, 132II, and 132III. The CF initiators 116A, 116B, 116C, 116D, and 116E may be referred to as initiators with virtual NVMe disks.

In certain embodiments, the NVMe disks 166 are physically located in the CF targets 1321, 132II, and 132III. The CF targets 132 with available storage capacity may form an “available storage pool,” which may be available as candidate storage resources every time a new workload needs storage adjustment. This workload management is at least partially accomplished via the process of composing and re-composing the DSS node 112 described herein according to one or more embodiments of the present disclosure.

In certain embodiments, upon request, the resource manager 120 may search for available CF targets, such as any of the CF targets 1321, 132II, and 132III depicted in FIG. 1, for candidate CF targets with NVMe disks that are not used to its capacity. Once the resource manager 120 finds the CF targets with available storage capacity, these CF targets are placed on a candidate list for immediate or future composition needs.

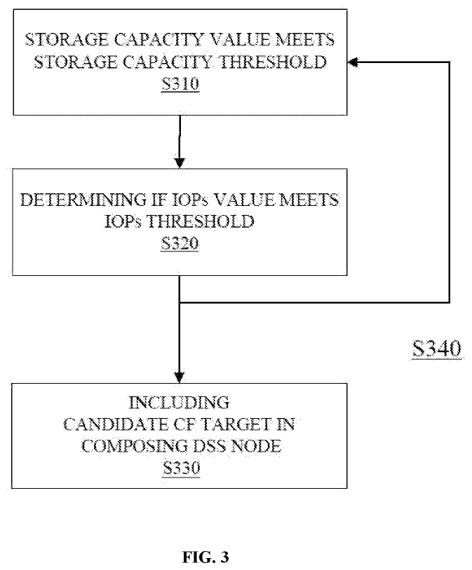

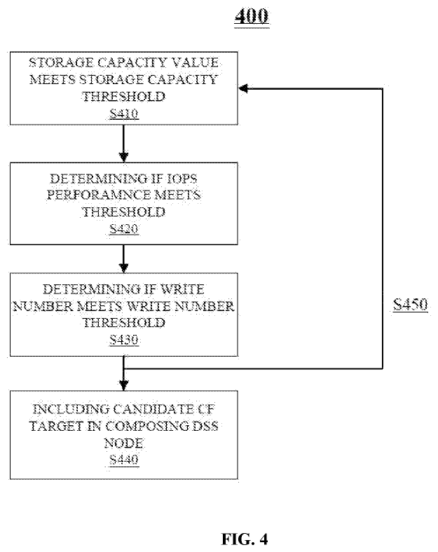

In certain embodiments, one or more additional selection criteria such as the IOPs performance and the write number may be considered in selecting storage devices in the composition process. The resource manager 120 may check the IOPs of the CF targets in the “available storage pool,” and select the CF targets with IPOs above certain preset threshold, for example, according to a sub-process illustratively depicted in FIG. 3. The resource manager 120 may also check the write number of these CF targets in the “available storage pool” list, and select the CF targets with write number value below certain preset threshold, for example, according to a sub-process illustratively depicted in FIG. 4.

The resource manager 120 may communicate with the CF targets 1321, 132II, and 132III through the management unit 156. The management unit 156 is a controller for the configuration of various computing elements in the CF targets 1321, 132II, and 132III including the memory, pooled storage, networking elements, and switch elements. The management unit 156 communicates to the resource manager 120 with information about the management unit 156 and the NVMe disk 166. The management unit 156 also executes instructions received from the resource manager 120 on configuring and reconfiguring the composition of the DSS node 112, including mapping and/or un-mapping any of the CF targets 1321, 132II, and 132III, and in particular, the virtual NVMe disks of the CF targets 1321, 132II, and 132III.

According to one or more embodiments of the present disclosure, FIG. 1B is a schematic structural diagram of the resource manager 120 of FIG. 1. The resource manager 120 may include a processor 510, a memory 520, a data storage 530, an I/O subsystem 550, a display 560, and a communication circuitry 540, in data communication with one and another.

The processor 510 may be a single CPU (Central Processing Unit), but it may also include two or more processing units. For example, the processor 510 may include a general-purpose microprocessor, an instruction set processor, and/or an associated chipset, and/or a special purpose microprocessor, for example, an application specific integrated circuit (ASIC).

The memory 520 may be embodied as any type of volatile or non-volatile memory or data storage capable of performing the functions described herein. In operation, the memory 520 may store various data and software used during operation of the resource manager 120 such as operating systems, applications, programs, libraries, and drivers. The memory 520 is communicatively coupled to the processor 510 via the I/O subsystem 550, which may be embodied as circuitry and/or components to facilitate input/output operations with the processor 510, the memory 520, and other components of the resource manager 120.

The memory 520 may be a computer program instruction product. Computer program instructions may be carried out by a computer program instruction product such as the memory 520 connected to a processor. The computer program instruction product may include a non-transitory computer-readable medium having computer program instructions stored thereon. For example, the computer program instruction product may be a flash memory, a random access memory (RAM), a read-only memory (ROM), and an EEPROM, and the above-mentioned computer program instruction module may be distributed to different computer program instruction products in the form of storage device included in the UE.

The communications bus 176 may transfer data between computing elements in the CF targets 1321, 132II, and 132III. The communications bus 176 may be a switching fabric, such as a Peripheral Component Interconnect Express (PCIe), Infiniband, Omni-Path, or Ethernet network.

The CF targets 1321, 132II, and 132III may further include a CF NIC (Network Interface Card) which may communicate with another CF NIC included in CF target 1321, 132II, or 132III and in CF initiators 116A, 116B, 116C, 116D, or 116E via the network 118 which may be an ethernet. Through this communication, the CF initiators 116, such as the CF initiators 116A, 116B, 116C, 116D, or 116E are remotely mapped with the CF targets such as the CF targets 1321, 132II, or 132III to perform various tasks.

The CF targets 1321-132X may each include an input-and/or-output (I/O) adaptor 186 to record the IOPs value. The CF targets 1321-132X may also include a write number recorder 196 to record the write number performed on CF targets 132.

The CF targets 1321, 132II, and 132III are configured to host one or more workloads. A workload is a process or group of processes that performs a function using data stored on data drives. Workloads may be isolated applications, virtual machines, hypervisors, or another group of processes that work together, using data on a data drive, to perform a function.

The NVMe disks 166 may be remotely attached to CF initiator 116A, 116B, 116C, 116D, or 116E. The NVMe disks 166 are configured to store data used by one or more workloads. The NVMe disks 166 may be virtual disks of CF initiator 116A, 116B, 116C, 116D, or 116E that are mapped to physical drives of one more disks drives of CF targets 1321, 132II, and 132III.

The virtual NVMe disks of the CF initiator 116A, 116B, 116C, 116D, or 116E may be communicatively connected to the management unit 156, which communicates with the resource manager 120.

Referring back to FIG. 1, the resource manager 120 may communicatively monitor, on a regular or intermittent basis, workload affinity and process data migrations inside resource cluster 110 via the communication channel 140. Such monitoring may be conducted on various levels and at various nodes, such as monitoring resource utilization, monitoring wear levels of data drives, and tracking mappings between data drives and composed nodes.

Referring back again to FIG. 1, a CF targets pool 130 may include one or more CF targets 132 with NVMe disks 166, such as CF targets 1321, 132II, and 132III depicted in FIG. 1. The CF targets such as CF targets 1321, 132II, and 132III may use NVMe disks 166 to store data and process workload associated with one or more the CF initiators such as CF initiators 116A, 116B, 116C, 116D, and 116E via a network 118, which may be an ethernet.

FIG. 1C is a schematic diagram of another arrangement of computing environment 100 referenced in FIG. 1. As shown in FIG. 1C, a resource cluster 110B may include more than one DSS nodes 112. The resource cluster 110B may include, for example, a first DSS node 112a and a second DSS node 112b. One or more CF initiators such as CF initiators 116A, 116B, and 116C are in communication with the first DSS node 112a via a first network 114a. One or more CF initiators such as CF initiators 116D and 116E are in communication with the second DSS node 112b via a second network 114b. The CF target pool 130 may communicate with the first DSS node 112a via network 118a and with the second DSS node 112b via network 118b.

As shown in FIG. 1C, DSS nodes 112a and 112b may share the use of certain target devices, such as CF targets 1321, 132II, and 132III. In certain embodiments, DSS node 112b may request more storage from resource manager 120. The resource manager 120 may search for available CF targets, such as any of the CF targets 1321, 132II, and 132III depicted in FIG. 1C, for candidate CF targets with NVMe disks that are not used to its capacity. Once the resource manager 120 finds the CF targets with available storage capacity, these CF targets may be placed on a candidate list for immediate or future composition needs.

In some embodiments, one or more additional selection criteria such as the IOPs performance and the write number may be considered in selecting storage devices in the composition process. The resource manager 120 may check the IOPs of the CF targets in the “available storage pool,” and select the CF targets with IPOs above certain preset threshold, for example, according to a sub-process illustratively depicted in FIG. 3. The resource manager 120 may also check the write number of these CF targets in the “available storage pool” list, and select the CF targets with write number value below certain preset threshold, for example, according to a sub-process illustratively depicted in FIG. 4.

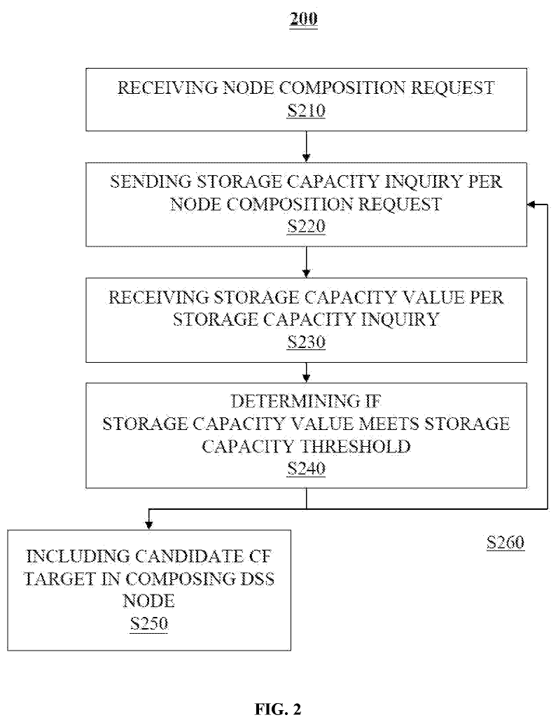

FIG. 2 is a schematic flow diagram of a method 200 of composing a client node, such as the DSS node 112 referenced in FIG. 1.

At step 210, the resource manager 120 may receive a node composition request. The node composition request may be a request to add or remove a CF initiator, such as the CF initiators 116A, 116B, 116C, 116D, or 116E, to from the DSS node 112, or to add storage capacity to any of the CF initiators 116A, 116B, 116C, 116D, or 116E. Adding or removing a CF initiator may be conducted via mapping or un-mapping the CF initiator relative to a given DSS node 112. In some embodiments, the resource manager 120 may map or un-map the virtual NVMe disks 166 remotely attached to the CF initiator 116A, 116B, 116C, 116D, or 116E to NVMe disks physical attached to the CF target 132. The node composition request may be a request to map any one of the CF initiator 116A, 116B, 116C, 116D, or 116E, or the NVMe disks 166 within the CF initiators 116 to another CF NVMe disks 166 with additional storage capacity.

In some embodiments, the node composition request may also be a request to create a new node, such as a new DSS node 112. The resource manager 120 may then identify available CF initiators 116 and CF targets 132 to compose a new DSS node upon request. FIG. 1C, for example, provides more details of a resource cluster 110B with more than one DSS nodes 112. The node composition request may be initiated by a system administer overseeing the resource cluster 110B or by resource manager 120, and may also be based on feedback data or signals from the resource cluster 110B via any suitable communicative data, and or on feedback data or signals from a CF targets pool 130 in communication with the resource cluster 110B.

At step 220, after receiving the node composition request, the resource manager 120 may send a storage capacity inquiry to a storage pool. The storage pool may include all CF targets 132 that are managed by the resource manager 120. For example, the storage capacity inquiry may be an inquiry on whether any of the CF targets in the “available storage pool,” such as CF targets 1321-132III has available capacity to meet additional storage demands. The capacity inquiry may be conducted via a determination process as to whether a storage capacity of the NVMe disks of the CF targets in the storage pool meets a preset storage capacity threshold, such as whether an NVMe disk is 60% full, 50% full, or 40% full, etc.

Table 1 below provides an exemplary “available storage pool,” which is further referenced below when describing the composition method consistent with the present disclosure. For ease of description, in this example, each CF target 132 includes one NVMe disk 166. In some embodiments, each CF target 132 may include multiple NVMe disks 166. Composition method consistent with the present disclosure may then implement the same method at the level of each NVMe disk 166.

TABLE 1
Available Storage Pool

| | CF | CF | CF | CF | CF | CF | CF | CF | CF | CF |
|---|---|---|---|---|---|---|---|---|---|---|
| | target | target | target | target | target | target | target | target | target | target |
| | 132I | 132II | 132III | 132IV | 132V | 132VI | 132VII | 132VIII | 132IX | 132X |
| Storage | 40% | 50% | 60% | 70% | 40% | 50% | 60% | 70% | 45% | 35% |
| Fullness | | | | | | | | | | |
| IOPs | 1,000 | 500 | 1,200 | 400 | 1,000 | 500 | 1,200 | 400 | 800 | 700 |
| (MB/s) | | | | | | | | | | |
| TBW | 600 | 300 | 150 | 500 | 600 | 300 | 150 | 500 | 600 | 700 |

As step 230, individual storage capacity values of the CF targets in the “available storage pool,” such as CF targets 1321-132X in Table 1, may be reported back to the resource manager 120. At step 240 the resource manager 120 may determine whether the storage capacity of a CF target 132 meets the preset storage capacity threshold. Referring to the example in Table 1, for example, the resource manager 120 may set the storage capacity threshold at 50%. CF targets 132 with 50% or more capacity available would then be selected for composition. That is, CF targets 1321, 132II, 132V, 132VI, 132IX, and 132X (132IV-132X are not shown in the Figures) would be selected.

At step 250, upon determination that the storage capacity value of any of the CF targets 132 has available storage capacity, in one embodiment, the DSS node 112 may be recomposed by mapping the available storage from CF targets 132 to any of the relevant CF initiators 116A, 116B, 116C, 116D, or 116E. In another embodiment, the resource manager 120 may compose a list of available CF targets to identify CF targets with available storage capacity.

Referring to the example shown in table 1, CF targets 1321, 132II, 132V, 132VI, 132IX, and 132X may have NVMe disks that are less than 50% full. In one embodiment, the resource manager 120 may include the available storage capacity from a candidate CF targets 1321, 132II, 132V, 132VI, 132IX, and 132X in re-composing the DSS node 112 by mapping the NVMe disks physically attached to the candidate CF targets 132 to one or more CF initiators 116. In another embodiment, the resource manager 120 may compose a list of available CF targets to identify 1321, 132II, 132V, 132VI, 132IX, and 132X as targets with available storage capacity.

At step 260, if the resource manager 120 determines that none of the CF targets 132 have available storage capacity, in one embodiment, the method 200 goes back to step 220 in search for CF targets that may have available storage capacity. In some embodiments, if the resource manager 120 may determine that the storage capacity of any of the CF targets 132 in the storage pool does not meet the preset storage capacity threshold, i.e., none of the CF targets 132 has at least 50% available storage capacity, the resource manager 120 may send the storage capacity inquiry to other available resource pools. Alternatively, the resource manager 120 may start the process of checking the current “available storage pool” again starting from step 220. The resource manager 120 may start the process of checking the current “available storage pool” again starting from step 220 at a set time interval, or at any time interval defined in the resource manager 120.

FIG. 3 is a schematic flow diagram of a sub-method 300 that may be integrated into the method for composition of a DSS node as shown in FIG. 1 or for composition of multiple DSS nodes, as shown in FIG. 1C. The sub-method 300 may be implemented between steps 240 and 250 or between steps 240 and 260 of FIG. 2.

At step 310, the resource manager 120 determines that the available storage capacities of the CF targets, for example CF targets 1321, 132II, 132V, 132VI, 132IX, and 132X meet the preset storage capacity threshold (e.g., 50% available NVMe disk space).

At step 320, the resource manager 120 determines whether IOPs performance of the CF targets 1321-132X meets an IOPs threshold. Referring back to Table 1, the CF targets 1321-132X may each include an input-and/or-output (I/O) adaptor 186 to record the IOPs value. The resource manager 120 may set a threshold for the IOPs to further select available targets 132 with preferred IOPs performance data.

As with the storage capacity threshold, the value of the IOPs threshold may be set to a different value as needed. If the resource manager 120 sets the IOPs threshold at a different value, a given CF target such as the CF targets 1321-132X may change its status from being previously mapped to now unmapped, or alternatively from previously unmapped to now mapped.

Referring to the example shown in Table 1 above, the resource manager 120 may set an IOPs threshold at 500 MB/s. That is, the resource manager 120 would select available CF targets 132 which have IOPs equal to or faster than 500 MB/s to compose or re-compose DSS nodes. Among CF targets 1321-132X in Table 1, targets 1321, 132II, 132III, 132V, 132VI, 132VII, 132IX, and 132X meet the required IOPs performance requirement. In step 240 of FIG. 2, the resource manager 120 also determined targets 1321, 132II, 132V, 132VI, 132IX, and 132X have the required storage capacity. As such, the resource manager 120 may determine that CF targets 1321, 132II, 132V, 132VI, 132IX, and 132X meet both the storage capacity requirement and the IOPs performance requirement, and therefore may be used to re-compose DSS node 112.

At step 330, upon determining that the IOPs value meets the IOPs threshold, the identified CF targets 132 may be included in the “available storage pool” for composing the DSS node 112. Referring to the example shown in Table 1, the resource manager 120 may include CF targets 1321, 132II, 132V, 132VI, 132IX, and 132X in the “available storage pool” for composing the DSS node 112.

Steps 310, 320, and 330 work together as a second filter, applied after the first filter based on the storage capacity determination outlined in FIG. 2, to further narrow down to a more targeted subset of the CF targets such as CF targets 1321, 132II, 132V, 132VI, 132IX, and 132X, as candidates to be composed into the DSS node 112. This second filter enabled by the IOPs value determination may be used to sort a large number of CF targets and identify CF targets with fast IOPs performance to be included in the composition of the DSS node 112. That is, the resource manager 120 may first identify a first set of CF targets with available storage capacity meeting the storage threshold, and then further identify a second set of RSG targets within the first set of CF targets that have fast IPOs performance meeting a IOPs threshold.

At step 340, if the resource manager 120 determines that the IOPs values of CF targets in the pool do not meet the preset IOPs threshold, the CF targets 132 may not be included in this round of the process of composing the DSS node 112, and the sub-method 300 may go back to step 310 in search for additional CF targets that may meet the IOPs performance threshold.

FIG. 4 is a schematic flow diagram of a sub-method 400 that may be integrated into the method for composition of a DSS node as shown in FIG. 1 or for composition of multiple DSS nodes, as shown in FIG. 1C. The sub-method 300 may be implemented between steps 240 and 250 or between steps 240 and 260 of FIG. 2.

At step 410, the resource manager 120 may determine that the storage capacity value of the CF targets 132 meets the preset storage capacity threshold. As with step 240 in FIG. 2, the preset storage capacity may be reset to a different value as needed such that any given CF targets may be re-mapped or un-mapped in response to the reset. Referring to the example shown in Table 1, the resource manager 120 may include CF targets 1321, 132II, 132V, 132VI, 132IX, and 132X in the “available storage pool” for composing the DSS node 112.

At step 420, upon determining that the IOPs value meets the IOPs threshold, the CF targets 132 may be included in the “available storage pool” for composing the DSS node 112. Referring to the example shown in Table 1, the resource manager 120 may include CF targets 1321, 132II, 132III, 132V, 132VI, 132VII, 132IX, and 132X which meet the IOPs threshold requirement. The Resource manager 120 may include CF targets 1321, 132II, 132V, 132VI, 132IX, and 132X in the “available storage pool” for composing the DSS node 112 because these CF targets 132 meet both the storage capacity requirement and the IOPs performance requirement set by the resource manager 120.

At step 430, the resource manager 120 determines whether a write number of the CF targets 1321-132X meets a write number threshold. Referring back to Table 1, the CF targets 1321-132X may also include a write number recorder 196 to record the write number performed on CF targets 132. The write number may include a value on a read speed, a write speed, or both. The read speed and the write speed are often used to measure the performance of a storage device. While a read speed refers to how long it takes to open a file from the CF target, the write speed is how long it takes to save a file to the CF target. Any suitable program such as CrystalDiskMark may be used to test the read/write speeds of the NVMe disks 166 of the CF targets 1321-132X and the test results may be recorded by the write number recorder 196.

In some embodiments, the NVMe disks 166 of CF targets 1321, 132II, 132III, 132IV, 132V, and 132VI may include a hard disk drive (HDD), a solid-state drive (SSD), or a combination of both. The SSDs use semiconductors to store data and therefore have faster read and write speeds than HDDs in general. The read/write speeds become more impactful when the workload involves a large number of files, a large number of large files, and many different tasks, which is the case with distributed storage architecture as the structure illustratively depicted in FIG. 1.

As with the storage capacity threshold or with the IOPs threshold, the resource manager 120 may set a write number threshold to a different value as needed. After such a reset, a given CF target may change its status from being previously mapped to now unmapped, or alternatively from previously unmapped to now mapped.

Referring to the example shown in Table 1, NVMe disks of CF targets 132 may have various lifespan measure in Terabyte of Writes (TBW). For example, CF target 1321 may have a NVMe disk with a lifespan of 1,000 TBW, which means that the NVMe disk is expected to operate normally if the total IOPs over time is under 1,000 TBW. The NVMe disk with a lower cumulative TBW is expected to have a longer remaining lifespan.

In step 430, the CF targets 132 may have same lifespan. The resource manager 120 may set a write number threshold, for example, at 300 TBW. That is NVMe disks with 300 TBW and few are considered to have sufficiently long remaining lifespan. As such, the resource manager 120 may determine that CF target 132II, 132III, 132VI, and 132VII meet the write/wear threshold.

At step 440, once the resource manager 120 determines that the write number value meets the write number threshold, the corresponding CF targets 132 may be included in the process of composing the DSS node 112. The steps 430 and 440 work together as a third filter, after the first filter based on the storage capacity determination outlined in FIG. 2 and second filter based on the IOPs value consideration illustratively depicted in FIG. 3 are implemented, to further narrow down the selection of RSG targets 132 to a smaller subset of the CF targets, as candidates to be mapped onto the CF initiators 116A-116E. This third filter is useful when the resource manager 120 composes a system based on a large number of CF targets and the workload is expected to be write intensive.

Referring to the example shown in Table 1, the resource manager 120 determines that only CF targets 132II and 132VI meet the storage requirement, the IOPs performance requirement, and the write/wear requirement. Therefore, CF targets 132II and 132VI may be used in composing or re-composing DSS node 112.

At step 450, once the resource manager 120 determines that the write number exceeds the preset write number threshold, the CF targets such as CF targets 1321 may be excluded in this round of the process of composing the DSS node 112, and the sub-method 400 may go back to step 410 to restart inquiry for CF targets satisfying the storage capacity criteria.

Depending on the profile of DSS node 112, and the nature of the workload that is handled, the resource manager 120 may give priority to certain criteria when searching for CF targets 132. For example, if the DSS node 112 hosts a database for storing a large volume of image data, when the DSS node 112 requests more storage, the resource manager 120 may search for CF targets 132 with more storage capacity, but with more lenient requirements on IOPs performance or the write/wear level. In another example, the DSS node 112 may host a real time facial image recognition application. Once the DSS node requests more storage from the resource manager 120, the resource manager may search for CF targets 132 with faster IOPs performance with more lenient requirements on storage capacity or the write/wear level.

In certain embodiments of the present disclosure, both sub-method 300 and sub-method 400 may be integrated to method 200, such as to be used to replace steps 230 and 250 of method 200 of FIG. 2. This method provides more rules for a resource manager to determine which of the CF targets and/or the CF initiators can be mapped to a DSS node, such as the DSS node 112.

The display 560 may be embodied as any type of display capable of displaying digital information such as a liquid crystal display (LCD), a light emitting diode (LED), a plasma display, a cathode ray tube (CRT), or other type of display device.

Although the present disclosure has been shown and described with reference to specific exemplary embodiments thereof, those skilled in the art will understand that, without departing from the spirit and scope of the present disclosure as defined by the appended claims and their equivalents, various changes in form and detail may be to the present disclosure. Therefore, the scope of the present disclosure should not be limited to the embodiments described above, but should be determined not only by the appended claims, but also by the equivalents of the appended claims.

What is claimed is:

1. A method of composing a DSS (distributed storage system) node by a resource manager, the method comprising:
receiving a node composition request;
sending to a candidate CF (composable fabric) target a storage capacity inquiry according to the node composition request;
receiving a storage capacity value in response to the storage capacity inquiry;
determining whether the storage capacity value meets a storage capacity threshold; and
upon determining that the storage capacity value meets the storage capacity threshold, composing the DSS node by including the candidate CF target.

2. The method of claim 1, further comprising:
receiving an IOPs value of the candidate CF target;
determining whether the IOPs value meets an IOPs threshold; and
upon determining the IOPs value meets the IOPs threshold, composing the DSS node by including the candidate CF target.

3. The method of claim 1, further comprising:
receiving a write number of the candidate CF target;
determining if the write number meets a write number threshold; and
upon determining the write number meets the write number threshold, composing the DSS node by including the candidate CF target.

4. The method of claim 1, wherein the node composition request includes workload information.

5. The method of claim 4, wherein composing the DSS node with the CF target includes:
mapping the candidate CF target to a CF initiator; and
mapping the CF initiator to the DSS node.

6. The method of claim 5, wherein the candidate CF target includes an NVMe disk, and the NVMe disk is mapped to a virtual disk of the CF initiator.

7. The method of claim 1, wherein the resource manager communicates with the DSS node, a CF initiator, and the candidate CF target.

8. A computing apparatus, comprising a memory and a processor coupled to the memory, the processor being configured to perform a method of composing a DSS (distributed storage system) node via a resource manager, the method comprising:
receiving a node composition request;
sending to a candidate CF target in a storage capacity inquiry according to the node composition request;
receiving a storage capacity value in response to the storage capacity inquiry;
determining whether the storage capacity value meets a storage capacity threshold; and
upon determining that the storage capacity value meets the storage capacity threshold, composing the DSS node by including the candidate CF target.

9. The computing apparatus of claim 8, wherein the processor is further configured to perform:
receiving an IOPs value of the candidate CF target;
determining whether the IOPs value meets an IOPs threshold; and
upon determining the IOPs value meets the IOPs threshold, composing the DSS node by including the candidate CF target.

10. The computing apparatus of claim 8, wherein the processor is further configured to perform:
receiving a write number of the candidate CF target;
determining whether the write number meets a write number threshold; and
upon determining the write number meets the write number threshold, composing the DSS node by including the candidate CF target.

11. The computing apparatus of claim 8, wherein the node composition request includes workload information.

12. The computing apparatus of claim 11, wherein composing the DSS node with the CF target includes:
mapping the candidate CF target to a CF initiator; and
mapping the CF initiator to the DSS node.

13. The computing apparatus of claim 12, wherein the candidate CF target includes an NVMe disk, and the NVMe disk is mapped to a virtual disk of the CF initiator.

14. The computing apparatus of claim 8, wherein the resource manager communicates with the DSS node, a CF initiator, and the candidate CF target.

15. A non-transitory computer-readable storage medium storing computer program instructions executable by a processor to perform a method of composing a DSS (distributed storage system) node via a resource manager, the method comprising:
receiving a node composition request;
sending to a candidate CF target in a storage capacity inquiry according to the node composition request;
receiving a storage capacity value in response to the storage capacity inquiry;
determining whether the storage capacity value meets a storage capacity threshold; and
upon determining that the storage capacity value meets the storage capacity threshold, composing the DSS node by including the candidate CF target.

16. The non-transitory computer-readable storage medium of claim 15, wherein the computer program instructions are further executable by the processor to perform:
receiving an IOPs value of the candidate CF target;
determining whether the IOPs value meets an IOPs threshold; and
upon determining the IOPs value meets the IOPs threshold, composing the DSS node by including the candidate CF target.

17. The non-transitory computer-readable storage medium of claim 15, wherein the computer program instructions are further executable by the processor to perform:
receiving a write number of the candidate CF target;
determining if the write number meets a write number threshold; and
upon determining the write number meets the write number threshold, composing the DSS node by including the candidate CF target.

18. The non-transitory computer-readable storage medium of claim 15, wherein the node composition request includes workload information.

19. The non-transitory computer-readable storage medium of claim 18, wherein composing the DSS node with the CF target includes:
mapping the candidate CF target to a CF initiator; and
mapping the CF initiator to the DSS node.

20. The non-transitory computer-readable storage medium of claim 19, wherein the candidate CF target includes an NVMe disk, and the NVMe disk is mapped to a virtual disk of the CF initiator.
